(19) United States
(12) Patent Application Publication
(10) Pub. No.: US 2002/0069248 A1
(43) Pub. Date: Jun. 6, 2002

(54) System and method for delivery and exchange of electronic data

(76) Inventors: Martin King, Zug (CH); Vladimir Rasin, Farmington Hill, MI (US)

Correspondence Address: Ladi Shogbamimu, SHOOK, HARDY & BACON L.L.P., 1200 Main Street, Kansas City, MO, 64105-2118, US

(21) Appl. No.: 09/927,681

(22) Filed: Aug. 10, 2001

Related U.S. Application Data
(63) Continuation-in-part of application No. 09/501,196, filed on Feb. 10, 2000.

(51) Int. Cl. G06F 15/16

(52) U.S. Cl. 709/204

(57) ABSTRACT

The present invention is a system and method which functions to deliver data files and documents in a portable format to recipients in a quick and reliable manner, through allocating resources over a communications link. Information can be sent to one or a plurality of other users, yet the data need only be sent once regardless of the number of intended recipients. Importantly, no buffering between the sender and recipient is required in any way. The invention also provides a unique common interface for the distribution and exchange of electronic data with a guaranteed speed of data transfer, while achieving the utmost in security. The present invention also permits a sender to receive accounting or tracking information from a receiver regarding the precise delivery status of the electronic message, functioning to allow for enhanced overall security of the system.

### CROSS REFERENCE TO RELATED APPLICATIONS

This application is a continuation-in-part and claims priority from the non-provisional application Ser. No. 09/501,196 filed Feb. 10, 2000, the contents of which are incorporated by reference.

### BACKGROUND OF THE INVENTION

The present invention relates to computing network environments. More specifically, this invention relates to a system and method for delivery and exchange of messages and media files on a network.

The delivery and exchange of electronic information on a network or the Internet has led to a prolific use of Electronic mail (Email) as a method for sending messages from one user or device to another. In addition, other technologies such as audio and video streaming have emerged to allow users to communicate with one another or participate in a presentation to multiple users.

An inherent problem in media file delivery and exchange on electronic networks currently exists because these methods are based on two basic forms of information exchange, namely “Push” and “Pull”. In the “Push” information exchange, a user connects to a network access point, that action is detected, and information is automatically sent to the user from a storage source. In the “Pull” exchange scenario, a connected user requests specific information or messages from a storage source and then the information is transferred to the user. In both basic forms of information exchange, information can be stored at the source or may be stored at a local Point of Presence (POP) or other centralized server. The requirement for storage in the aforementioned information delivery systems leads to several limitations. For example, there are restrictions on file sizes due to the amount of storage available on the local POP or central server. Duplication and storage of data on third party devices such as a POP or other server also creates a security risk for the end-users. In addition, the sender does not have any indication concerning where a particular file is located, whether or not the recipient has actually received the file, and whether there has been a breach in security, such as by the file being intercepted by another person. Furthermore, present delivery systems create an unnecessary duplication of traffic on the network infrastructure. This duplication occurs because the same connection is being utilized for delivery between the source, intermediate systems and multiple recipients. In effect, the same piece of data moves across the communications medium multiple times. For example, in a typical email message, the message data is first transported from the sender to the mail server, then the message data is transported from the mail server to a recipient's mail server, and then finally to the recipient. This effect is compounded as the number of recipients and/or the number of intermediate devices increases at each stage of the transfer, and the greater the size of the data being transported. The message data in the above example is stored on both of the email servers (which is beyond the control of the recipient and sender) and on the recipient devices. As a result, network resources are being inefficiently used and allocated, and a typical communications infrastructure is required to be scaled to accommodate the extra traffic at additional cost.

Another inherent problem exists in the current methods of streaming data delivery and exchange in network environments. These methods rely on community members, such as a group of users who have a need to receive or share data, to join and leave the stream by logging onto or off a centralized server. This requirement for centralized login limits the number of users through restrictions on the number of simultaneous login transactions that are supported by the server and the network connection to the server. Other limitations of these methods are that the communication of login device address information may pose a security risk to end-users, and community members have no indication if there is ever a breach of security or if the wrong member has received information about them. Yet another limitation is the lack or very minimal management, of the quality of the interaction of users with network resources. An even further limitation results from the fact that many of the existing multi-user systems operate on a point-to-point basis.

These prior art systems and methods provide media-file delivery and data exchange, but fail to provide an economical and scaleable solution. Furthermore, these prior and current systems and methods fail to conserve the integrity and security of the source electronic data. As a result, a need has developed for a technological advancement enabling users to distribute portable files to many recipients in a controlled, secure and economical manner with a guaranteed level of service. An additional need is for a system which also allows users to share resources without compromising the quality of service for any given resource and allows users to connect to other users within a given community without the need to disclose secure, private and confidential information to a third party. Finally, there is a need for such a system that is also capable of allocating independent resources that are not an integral part of the network environment.

### SUMMARY OF THE INVENTION

The present invention is a system which functions to deliver data files and documents in a portable format to recipients in a quick and reliable manner, through allocating resources over a communications link. In operation, a user sends a file or document to one or a plurality of other users, yet the data need only be sent once regardless of the number of intended recipients. Importantly, no buffering between the sender and recipient is required.

To accomplish the foregoing, the system uses channel management, which is performed through handshaking between the participants or through a management system, to control and supervise channels defined on the network using a unique addressing and bandwidth reservation scheme. Users are able to specify the exact manner in which they want the messages to be transmitted, including preferred transfer priority, transfer speed and time of sending. Some of these sender preferences may be based on the recipients ability to receive information. However, in no case can a given transaction take place at a speed or other parameters that exceed the underlying network maximums. Given these constraints, the system of the present invention arranges for the delivery of information with terms and conditions that match the user's specifications as closely as possible. As with network speed and other transfer parameters, the present invention provides a guarantee of service that is within the parameters of the network level of service.

The present invention provides a unique common interface for the distribution and exchange of electronic data with a guaranteed speed of data transfer, while achieving the utmost in security. Thus, distribution is performed in a controlled, secure, and economical manner, with a guaranteed level of service that was previously unavailable. The present invention also permits a sender to receive delivery accounting or tracking information from a receiver regarding the precise status of the electronic message, thereby allowing for enhanced overall independence and control by the sender and recipient of the system.

### BRIEF DESCRIPTION OF THE DRAWINGS

FIG. 1 is a conceptual illustration of a Guaranteed Quality of Service (GQOS) Worldwide network.

FIG. 2 is a typical hardware layout for a GQOS network and a backbone wide Local Area Network.

FIG. 3 is a block diagram of the specific components within the present invention system architecture, enhanced to include numerical labels identifying the particular flow of information in the preferred mode.

FIG. 4 is a block diagram of a station and box that can be utilized to implement the present invention, along with their software component modules.

FIGS. 5-9 are illustrative flow diagrams of the present invention.

### DETAILED DESCRIPTION OF THE INVENTION

The present invention is a system and method for providing distribution and exchange of electronic data within a community of users, that supports the level of service provided to the users by the network. The system quickly and reliably delivers data files and documents in a portable format to one or more recipients over a communications link. The method of the present invention includes the sending of data to one or a plurality of other users, who constitute a community. The data file or document need only be sent once irrespective of the number of recipients. In addition, no buffering or storage of the data is required between the sender and the receiver. In an embodiment of the present invention, the various participants receive accounting information regarding the delivery status of electronic packages. The speed of data transfer to the receiving users is guaranteed by the automatic allocation and management of network resources. Furthermore, the present invention requires no additional infrastructure beyond a simple network connection to facilitate data transfer. Digital information travels directly from the sender's device to all the destination devices without the need for an intermediate server. The present invention is based on IP multi-cast and delivers information using as little bandwidth for communication to multiple destinations, as would be utilized in a single point-to-point delivery. In other words, a sending device no longer has to support many sequential or concurrent single cast sessions. Robustness and scalability are provided by the present invention, through network management and load management without the need for a server or centralized resource.

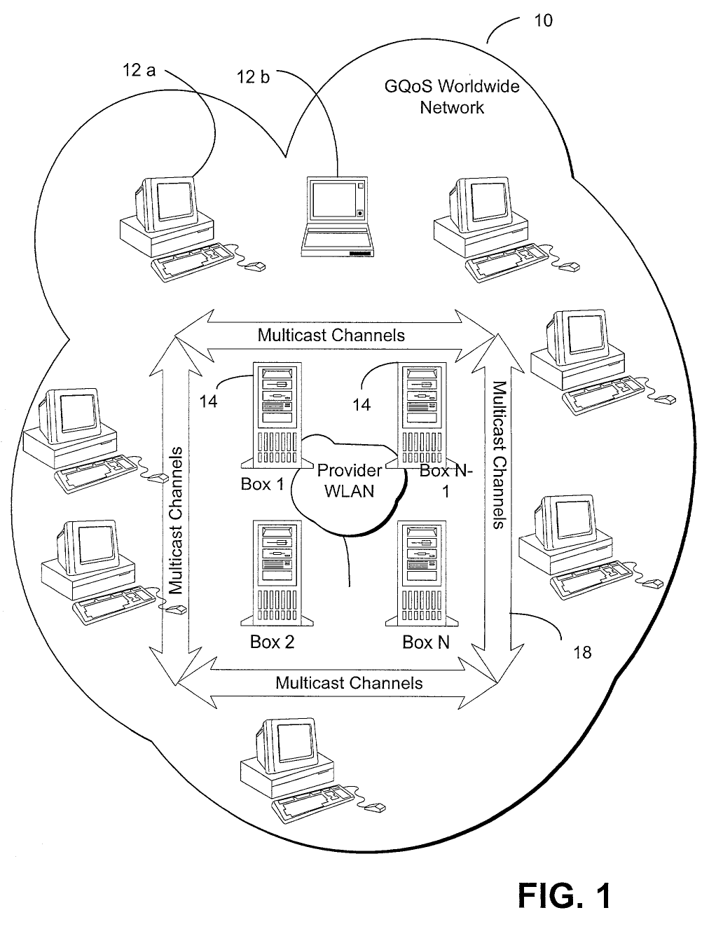

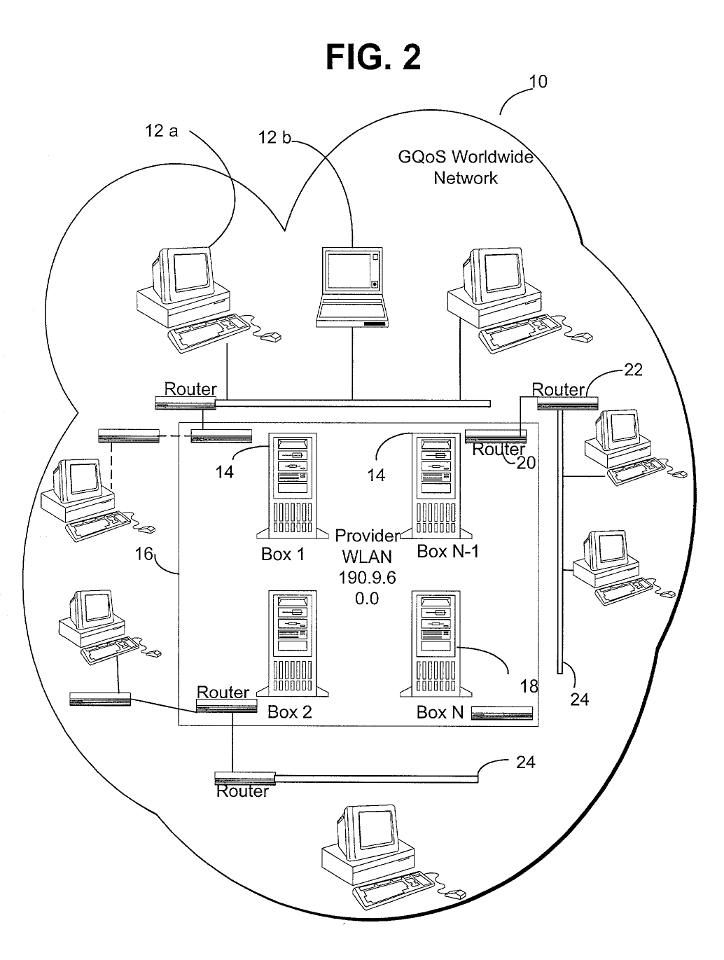

An overview of the present invention will be discussed with reference to FIG. 1, which is a conceptual illustration of an environment for practicing the invention. In the illustrated embodiment of the invention, the network environment consists of a world wide network with Guaranteed Quality of Service (GQOS) 10, multiple user stations 12, one or more network resource management boxes 14 that are connected on a provider's Wide Local Area Network (WLAN) 16, with multi-cast channels 18 to provide the means of communication between users. A more conventional illustration of a typical hardware layout for the network is shown in FIG. 2.

With reference to FIG. 1, while the GQoS network 10 is shown with the boxes 14, it should be noted that one of the novel features of the present invention lies in the fact that the presence of the boxes 14 is not mandatory. The GQoS network 10 is a subset of interconnected systems and devices on a Local Area Network (LAN), Wide Area Network (WAN), the Internet or other similar communications configuration. Box 14 is installed anywhere in a GQoS network 10 along with a set of stations 12. It should be noted that the network environment of the present invention does not have or require the hierarchy of devices that is found in traditional networks. Within the present invention, the box 14 is a peer device of equal standing in the network that happens to provide different functions from station 12. The stations 12 are typically located at an end-user's site and host an application program which enables sending, receiving and communication with other members of a community. A community is a grouping of devices much like an IP multi-cast group. In general, each station 12 can be managed through signaling from a specific box 14, which acts as a GQOS Point of Presence (POP) server. Box 14 accomplishes network management tasks for as many users as will be supported by processors speeds and network connections, enabling them to download software for the station 12, to register with the GQoS network 10. In other words, there are no technical limitations to the number of users that can be supported but rather the limitations exist by virtue of current technology limits such as network bandwidth. However in an embodiment of the present invention the number of users has been set to 50,000. The box 14 also offers load management services by pooling tasks and resources that can be used by many different stations 12, thus reducing the load of each single station 12. For example, telephone lines are shared by multiple users but during a phone call between two individuals, the line between them is arguably reserved and only those two individuals can utilize that line at that particular moment in time. In much the same way, box 14 handles resource allocation functions of that nature and provides channel information in terms of available channels and the respective speeds of those channels. The box 14 also publishes information about the users on the network eliminating the requirement for a centralized directory or address book.

As previously mentioned, communication occurs via multi-cast channels. Each community has a membership channel among many other channels. A detailed discussion of all the available multi-cast channels is beyond the scope of this invention and will only be referenced as needed in this document to explain the features of the invention. The membership channel is where each user notifies the community of his/her presence and the channel is defined over the world wide network 10 at the moment a user is present in the community. When boxes 14 are present, each one of the boxes 14 subscribes to each community membership channel (i.e. they list to these channels). A station 12 is subscribed to the membership channel of the community to which the user belongs.

Turning to FIG. 2, the backbone of the present invention lies on the provider's WLAN 16, which is within the GQoS multicast-enabled network 10, and is identified by a specific network address (e.g. 190.9.60.0) shown as the provider WLAN. Within the provider's WLAN 16, there are central routers 20 that communicate with each other and the supporting multi-cast channels. Box 14 is connected to the central router 20 which in turn is connected to remote router 22. Communications with remote user stations 12 on a network 24 are carried out through remote routers 22 to which stations 12 are connected. Routers are transparent in functionality and should be multicast enabled. A VPN (Virtual Private Network) can be utilized in environments that are not multicast enabled, such as the Internet, and there is no impact for the end user in terms of reconfiguration of their devices. It should be noted that the environment of the present invention does not require a device to have an IP address. A user device is typically listening on a channel and as such, data packets are sent to a channel rather than a particular device address. GQoS

The present invention is distinguishable from traditional broadcast protocols such as NETBIOS or channel specific networks such as broadband, in a number of ways. The channels in the current invention are dynamic, i.e. the channel only exists for the period of the transaction and resources are not reserved permanently. When a user is ready to send data, there is an announcement of the intention to send data, along with the channel on which the data will be sent. Then and only then is the channel reserved for transmission of that piece of data and the recipient tunes to that channel to receive the data during that point in time. The service announcement channels are the only exception to this rule.

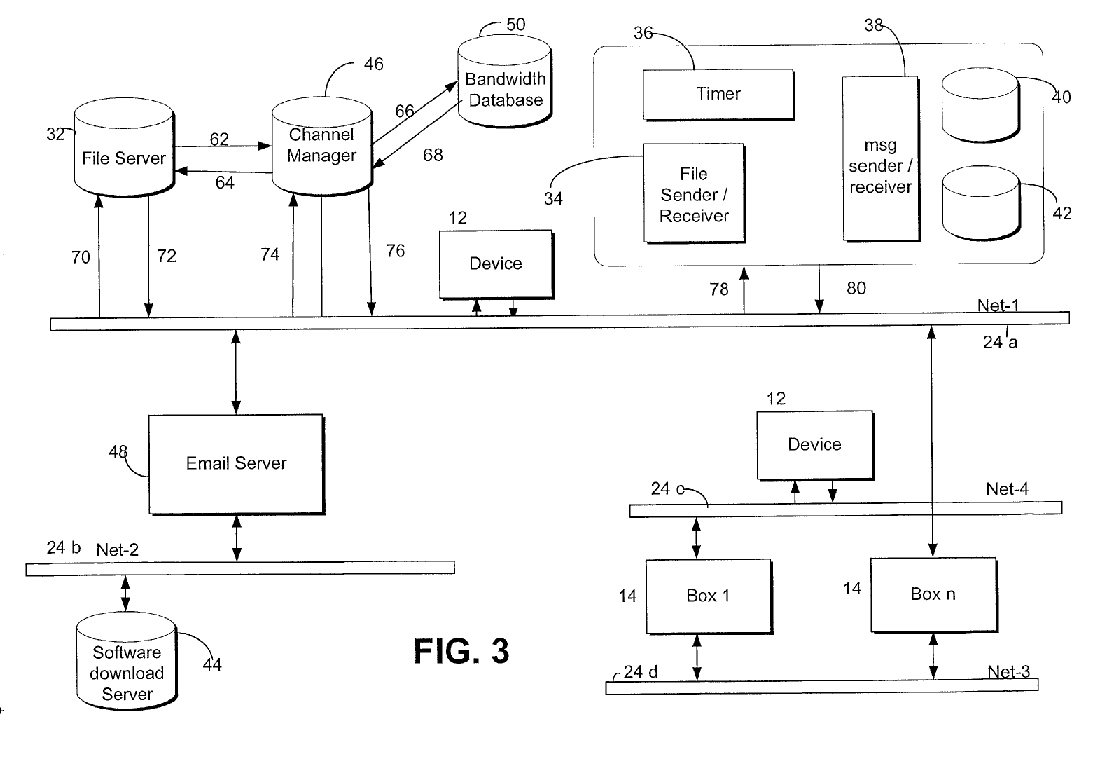

Further details on the inner workings of the present invention can best be understood with reference to FIG. 3, which is a block diagram illustration of some specific components within a system architecture for practicing the present invention. It should be noted that the illustrated architecture is provided for the purpose of explaining the overall construction and environment for practicing the invention. As shown, a file server 32 or other storage, may be present as a central repository for information, alternatively the information could be stored on the sending device 12. A channel manager 46 may also be present to handle the scheduling of information transfer in collaboration with a bandwidth database 50. On any of the illustrated networks 24, there can be multiple combinations of the previously mentioned components as well as multiple station devices 12. The station device 12 contains a file sender/receiver 34, a timer 36, a message sender/receiver 38, a resource store 40 and a recording store 42. In addition, for the purpose of communicating to other networks or the Internet, an email server 48 could also be present on the network. However, for connections to other networks 24 within the GQoS network 10 a box 14 is used, such as Box-n 14 that connects Net-3 to Net-1. In the operation of an embodiment of the present invention, a single station device 12 is capable of sending or receiving various data packets from a similar device or other network devices. Importantly, the devices are interconnected via network 24, which permits effective transportation of any such data packets. The channel manager 46 controls and supervises the channels defined on the network 24 using a unique addressing and bandwidth reservation scheme, the details of which will be discussed below. Bandwidth utilization on a given channel is monitored through the use of a bandwidth database 50.

One of the principal aspects of the present invention relates to file publishing, or the providing of data or information to be transferred to one or more other users. If a user wishes to publish a data file from user's device 12 to a number of other devices 12 attached to the network 24, or to a group of users, the following method would be applicable. In one embodiment, the user initializes the process through an event such as a keyboard input, mouse click, voice recognition or other means of triggering an event. Alternatively, the event may be triggered by an electronic agent, a time event or by a message received over a network. Typically, the user has predefined a time to send a file and a second time after which the file should not be sent. When the time to send the file is reached, the user device 12 will reserve a network resource to conduct the transaction of “file publishing” by accessing the resource store 40. A multi-cast channel will also be reserved via the channel manager 46. The method of channel reservation is discussed below. In the event that a resource is unavailable, the device 12 will wait until such a time as one becomes available.

For instance, as shown in FIG. 3, an initiating component is shown as file sender 32 and the following discussion will provide some detail on how information would be published. While the sender 32 is shown as a separate unit, it should be understood that this component may well reside within the station device 12. There could also be multiple file senders 32 on the network 24. The file sender 32 is not assigned to a channel. The file sender connects the data source with the channel, the file receiver connects the channel with the data destination File sender 32 requests approval or authorization in step 62, from the channel manager 46 that sending is appropriate at a particular time. A response is sent back to the file sender 32 at step 64. The file sender's request in step 62 indicates the size of the file to be sent and the bandwidth that would be required to transmit the file. The channel manager 46 then requests in step 66, from the bandwidth database 50, the most optimal time for data transfer. The channel manager 46 also attempts to ensure that the channel has sufficient free bandwidth, such that the file may be transmitted at the full speed on the requested channel. The speed of transmission is also based on the recipient's capability, which is communicated to the channel manger 46. The channel manager 46 calculates precisely how long it will take to send the file to its desired destination. The channel manager 46 searches the bandwidth database 50, for an available time that is closest to the time requested by the user, and still allow the file to be sent at the recommended or given speed. Upon completion of the search, the channel manager 46 replies in step 64 to the file sender 32 with the time at which the channel is available to transmit the particular data. In the event of a busy response, the channel manager 46 will reply that there is not sufficient free bandwidth to satisfy this specific request. On the other hand, if a time period for transmission is specified, the file sender 32 sets a timer 36 and upon the expiration of the period allocated to timer 36, the file sender 32 sends the file on the assigned channel in step 72. Such expiration will occur at a previously determined time interval consistent with the goals of the most optimal transfer of data possible. Importantly, the system provides a means for a single attached device to run multiple file sender processes to different attached network groups, for the purposes of efficiency and organization of data or information. It should be noted that all communication transactions, both by the sending device 12 and the recipient device 12, are recorded in the recording store 42. This function of recording activities provides both a transaction log and a means for verification of the activity.

The transfer of data files as indicated above entails several steps which may be performed by either the sending station device 12, the receiving station device 12 or one of the other components described herein. In a typical transfer, there is notification provided by the sending station device 12, followed by an acknowledge signal from a single or multiple recipient device 12 prior to a data transmission and recording of the notification and the acknowledge signal. The data transmission could be directed to one or multiple devices in a communication session or could take the form of a multi-cast data transmission. It should also be noted that the aforementioned sending notification can also be accomplished by a multi-cast transmission, which is then followed with a data transmission. Furthermore, the present invention also allows a data transmission to occur first, and then be followed by a notification from the recipient, and then a recordation of the activities. Should the user wish to publish to a plurality of users on another network, such as the Internet or other global computer network which is represented by network 24B, the user can automatically issue a secure e-mail message over net-I 24a. Such message will be resent by e-mail server 48. The e-mail message may also contain the configuration information that allows a user who is not a member of net-1 24a to download a receiving software from a software download server 44, which is a device that could be residing on net-2 24b. The receiving software permits connection to net-1 24a in order to receive the requested data.

Another aspect of the present invention relates to “file requesting”. For instance, in an embodiment of the present invention, a user of end-user device 12 who wishes to request a data file from file sender 32 initializes the process through an event such as a keyboard input, mouse click, or the like as discussed above. The device 12 with the requesting functionality sends a specific request on the channel, including the path of the requested file in step 80. The request, file size indication, the recommended bandwidth, and the location of the requested file, are sent to all file senders 32 that have been enabled to reply to requests. If file sender 32 maintains the requested file locally, the file sender 32 will send a request at step 62 to the channel manager 46, indicating the size of the file and the bandwidth at which the user wants to receive the file. Importantly, the channel manager 46 ensures that only one file sender 32 will reply.

In a manner that is similar to the file publishing, the channel manager 54 requests in step 66 from the bandwidth database 50, a transmission time that ensures that the channel has enough free bandwidth, such that the file may be transmitted at the full speed requested on the channel. Using all available information, the channel manager 46 calculates precisely how long it will take to send the file as requested. The channel manager 46 then searches in the bandwidth database 50, at step 66 for the closest available time to the time requested by the user to send the file at the determined speed.

Upon completion of the search at step 66, the channel manager 46 replies to the file sender 32 at step 64 with the time when the sender can transmit data, or with a busy response if there is not enough free bandwidth to satisfy this request. The file sender 32 sets the timer 36 and forwards the time of transmission to the requesting client in step 72. Upon expiration of a client timer 36, the client station 12 sends a second request, with an indication that such is the second request, to the appropriate file sender 32. This action causes the file sender 32 to send the file on the assigned channel without any further delay at step 72 and the file is received by the client station 12 at step 78. This aspect of the system can be expected to effectively satisfy those users whose electronic messages are the most time-sensitive in nature, allowing for same to be transmitted as soon as practically possible.

As previously discussed, the present invention provides for a variety of event sequences as a part of the data transmission. With regard to the request of electronic data, a receiving device can request a time during which it will be able to obtain data from a sending device. This request is followed with a notification of an appropriate time at which the data request should occur. At the allotted time, another request is made by the receiving device. The data is then transmitted. As in all previous data transmission cases, a record is made of the requests and notifications. It should be noted that the data transmission could be in the form of a direct transmission to one or more devices or in the form of a multi-cast transmission.

Yet another aspect of the present invention relates to conference streaming, wherein a user wishes to conference with a number of other users via devices 12 that are attached to the network 24. Here again as in the two previously discussed operations, the user initializes the process through an event. A messaging component 38 of the client device 12 signals to the target participants in a single transmitted message in step 80 that file will be sent via a reserved network resource. Upon receipt in step 78, the receiving messaging components configure the device 12 to conference via message sending/receiving component 38. The participants can then conference via an audio, video or text (chat) application. When the conference is complete, the initiator releases the network for other users by messaging to all connected devices 12 that the resource is free, thereby causing all receiving messaging components to configure their resource information accordingly. It should be noted that in the above described sequences, the conferencing technology is connected to the channel that is utilized for sending and receiving traffic. Messaging is used to steer and control the movement of data and to prevent congestion.

As previously mentioned, the activities relating to file publishing, file requesting and conference streaming could operate independently or with the aid of box 14 which could be on the same network, or located to provide communications across networks.

It should be noted that the variety of aforementioned techniques may be applied to the delivery of electronic documents over virtually any kind of network, and between virtually any kind of devices, greatly enhancing its overall utility. A common industry example, includes asymmetric networks where the forward and return channels may be realized using two simplex channels, one operating from the source to the sender and the other from the sender to the source. One of the key features of this invention lies in the recording of communications related information.

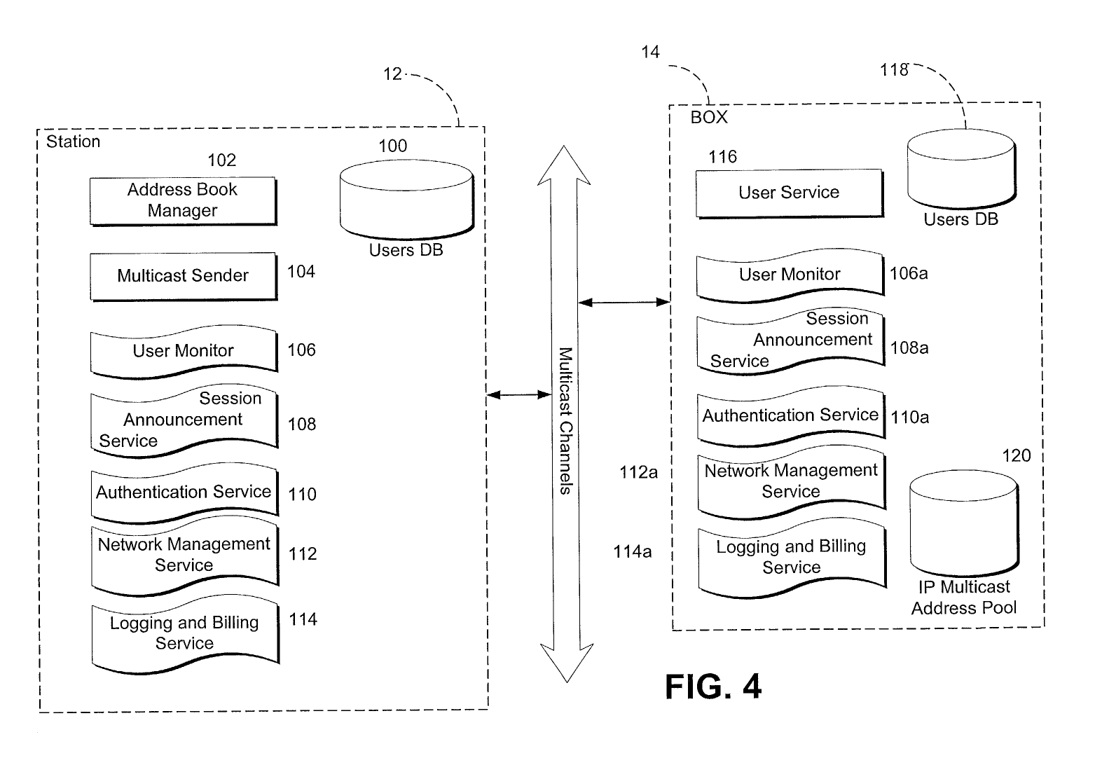

With regard to the figures and all descriptions herein, while the invention has been illustrated and described as embodied, the invention is not intended to be limited to the details shown. It should be understood that various omissions, modifications, substitutions and changes in the forms and details of the device and components illustrated and their operation can be made by those skilled in the art without departing from the scope of the invention. The functionality discussed thus far are made possible by various system components, which are illustrated in FIG. 4.

Turning to FIG. 4, the functions of file publishing, file request and conference streaming are actually enabled by software program module components within either the station 12 or the box 14. It is known to those of ordinary skill in the art that these modules, like any software modules, can be further broken down or combined or implemented in combination with hardware components, to achieve the same result, as such it should be understood that the following discussion is for illustrative purposes and should not be deemed to limit the scope of the present invention. As previously discussed, the stations 12 in the current invention are capable of operating in the absence of boxes 14. As such, the equivalent of certain components 106a-114a found in the boxes 14 are also available in the stations 12 as components 106-114. To facilitate this ability, the present invention records, both in individual stations 12 and on available boxes 14, information related to any new members (i.e. stations or boxes) that join a community.

The various functions available to a user of the current invention are made possible by system components 102-114 on the station 12. These functions include the storage and recall of a personal address book, receiving and/or transmitting documents from/ to any of the users of the inventive system, monitoring users that were inserted in the address book, announcing to a set of destination users that a transmission is about to take place, connecting and authenticating on the GQoS network, receiving of network management directives by the system, and visual representation of users' status and transmission progress through an intuitive user interface.

Similarly, box 14 provides network management and other functions using components 106a-114a and 116-120. The main tasks performed by the box 14 include, authenticating the user when he/she logs in to the network, centralizing network management facilities (i.e. IP Multi-cast address pool, BandWidth limitation on IP Multi-cast addresses . . . ) for the network operator, carouseling network management directives for stations dynamically, in order to distribute network configuration changes by an operator. Another service that can be provided on box 14 is load management, which is achieved by deploying on the box 14, the “pooling version” of the services that are already installed on the stations 12, through the system components 106a-114a. As previously noted, the stations 12 do not need the box 14 to function. The presence of the box 14 is merely detected when the box 14 is available and then the stations 12 rely automatically on the available load management pooling services, thus diminishing the load on the multi-cast channels.

The management and resource allocation functions available within the present invention are performed in a variety of ways. In one instance, a sending station device 12 could request a resource and then the receiving station device 12 and/or box 14 records the availability of that resource for future use. In another instance, a box 14 could request a resource, then a notification of the availability of the resource is sent to all station devices 12, which along with the box 14 could record the information for future use. In the situations where box 14 records availability or request or notification, the box 14 can also notify all stations 12 of the available resources, thus allowing each of the stations 12 to freely utilize the resources during a session transmission or multi-cast transmission.

The functionality provided by the various component modules of the present invention that are discussed above can be described as follows.

User service 116 handles modifications to all user attributes. This component is able to create a new user, to store the actual user status and reply to the “users status” queries coming from stations 12. Registered user information (personal info, users rights, users IP addresses, the community to which users belong, users' current status), will be stored in a database 118 accessible by the box 14. All boxes 14 can be interconnected, thus forming a distributed user database 118. The boxes 14 are thus able to broker each others' resources. User service 116 can communicate to other user services 116 on other boxes 14 to get information about users registered in a different box 14 (different community). The user service 116 is also responsible for carouseling out user information on each community's user info channel.

User monitor 106a on the box 14 side of the present invention system accepts station's 12 heartbeats on the heartbeat channel, and carousels out the list of users currently online, on each community membership channel. The user monitor 106 on the station 12 side listens to such carousels and keeps the list of monitored users updated. In the no-box configuration (i.e. when a box 14 is not present on the network 24), heartbeats are not used, instead each station 12 publishes its online status periodically, directly on the membership channel.

Authentication service 110 provides a means for all users to be identified and authenticated before accessing the system. Authentication info is retrieved by the User Service 116 from the user database 118. The authentication process also recognizes and grants access to roaming users.

Session announcement service 108 on the station side of is responsible for sending out session announcements on the community session announcement channel. The box 14 session announcement service 108a acts as a gateway to propagate such requests to other boxes 14 for all those destination users that are not local to the box.

Network management service 112a on the box 14 side is responsible for carouseling out community channel configuration and network management parameters. It is also responsible for collecting all IP multi-cast reservation requests published by its station-side companion network management service 112. The network management service 112, 112a accesses the IP Mcast address pool 120, tags as reserved the IP Mcast address requested by stations 12 and carousels out reservation replies. The same mechanism is used to answer release requests of IP Mcast addresses by stations 12. The network management service 112,112a also interacts with the user monitor 106, 106a to detect crashed stations 12 (i.e. stations that could not log off properly) in order to be able to release channels, thus avoiding resource starvation.

Logging and billing service 114 allows each station 12 to log and publish statistics on each content transmission session on the logging channel or on a logical channel on the session announcement channel. The box 14 side of the service 114a, collects all these statistics and groups them by user so that any billing system can access them.

Address book manager 102 is a station 12 only module that is responsible for storing each station's address book. It is anticipated that system upgrades it will be able to tune to the user info channel to get up-to-date user info carouseled by the user service.

Mcast sender and Mcast receiver 104 are two modules that are responsible for sending and receiving files on unreliable Mcast IP addresses through Forward Error Correction Protocol. They implement transmission, abort and pause (on the sender side only) and transmission resume for paused transmissions.

The station software of the present invention is also capable of being downloaded via the Internet. A user can download the software and register him/herself in one community. It is also possible for the software setup be done at download time, including that of the required application such as a video conferencing program or other applications.

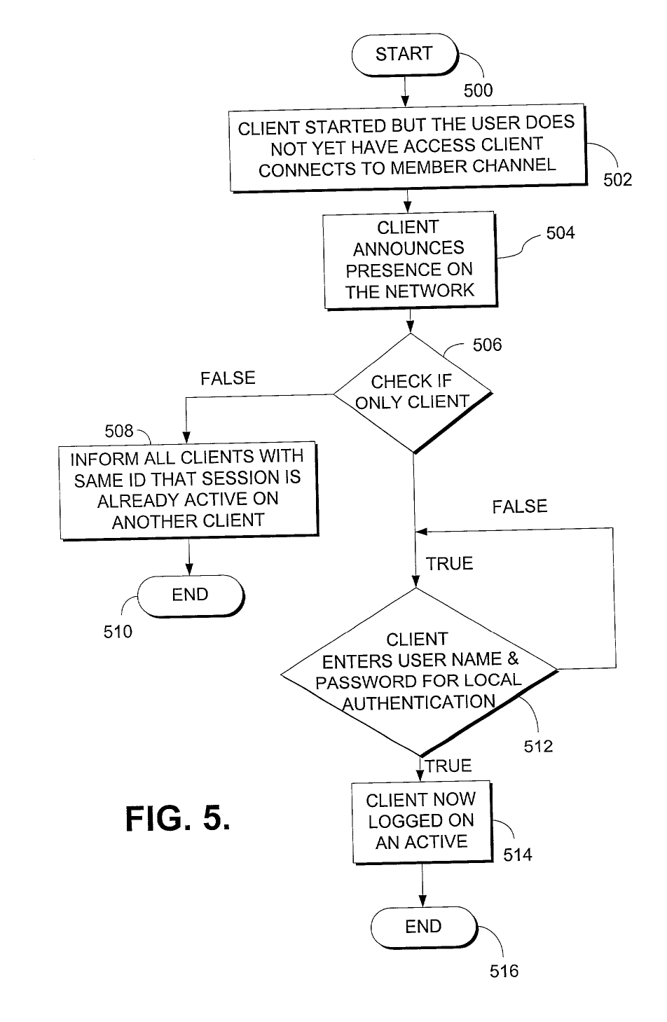

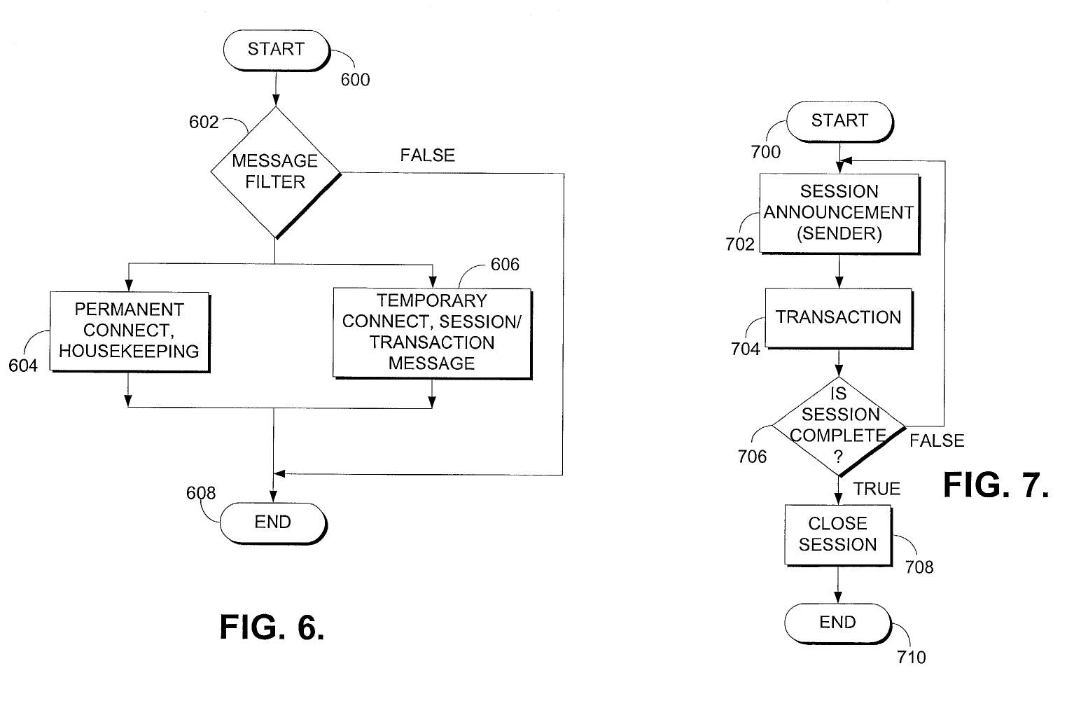

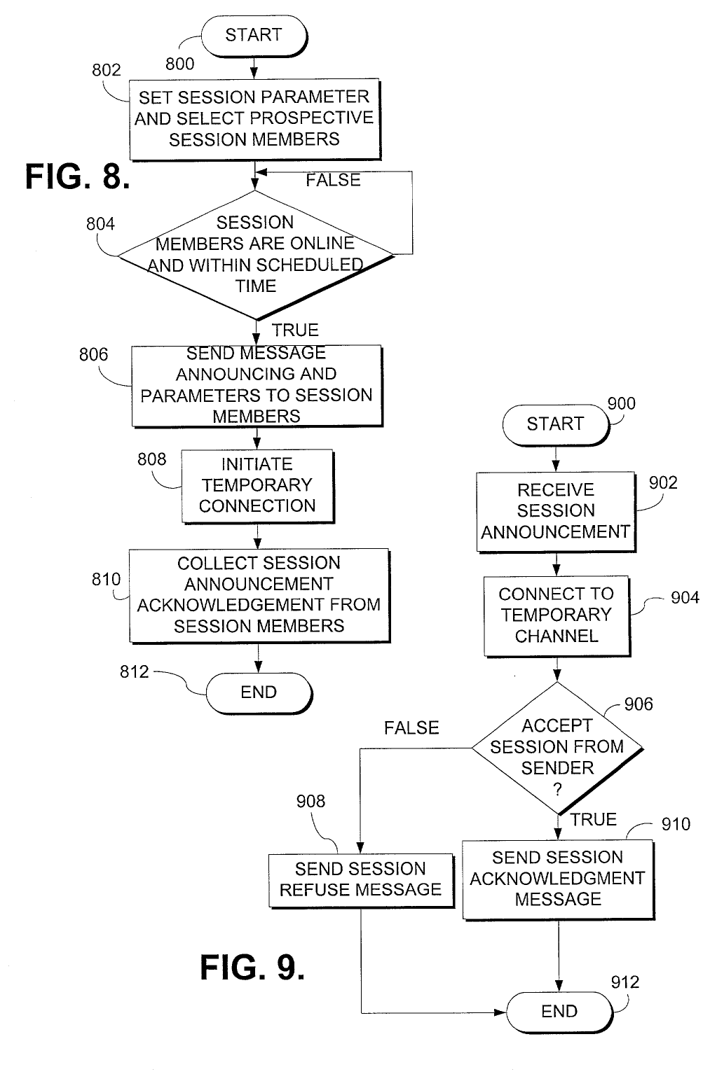

A further understanding of the present invention and the features that it provides can best be obtained by reference to the flow charts provided in FIGS. 5 to 9. As previously discussed, the starting point is the startup and login of a station 12 to the community. As shown in FIG. 5, a client or station 12 must first connect to a membership channel at step 502, then the client announces its presence at step 504. At this point, there is a verification for the presence of other clients with the same identification at steps 506 to 508. In the event that the current client has a unique identification, the client provides a user name and password for local authentication at step 512. This process is repeated until the login is successful at which point, the client becomes active on the network. Once active status is achieved, the client may then send and receive messages. Station 12 on the network essentially filters incoming messages into one of two categories as shown in FIG. 6. Provided that a message is received at step 602, a determination is made as to whether the message is one on the permanent channel connection such as station announcements or other housekeeping messages, as shown in step 604, or whether a temporary channel connection is required, such as to establish a transaction session, as shown in step 606. In the event that a transaction is to be performed as shown in FIG. 7, the initiating station 12 (sender) announces a session at step 702. As previously discussed a station 12 may or may not wait for the acknowledgement of a session announcement before a transaction is commenced. In any event, the transaction takes place at step 704, followed by a verification that the session is complete, so that the session can be closed at step 708 and channel resources can be relinquished. The session announcement at step 702 comprises a few other details which will be discussed with reference to FIG. 8.

Turning to FIG. 8, a component of a session announcement is shown in step 802, where session parameters are set and session members are identified. If all session members are online within the scheduled time at step 804, a message is sent at step 806 announcing the session parameters to those members. A temporary connection is established at step 808 to the session members, in order to receive acknowledgements at step 810. The sequence of events that lead to the acknowledgement will be discussed with reference to FIG. 9.

There are situations where a recipient station 12 must acknowledge the session announcement that occurred at step 702. In that case, the sequence of events that occurs on the receiving station 12 (receiver) are shown in FIG. 9. When a session announcement is received at step 902, the receiver at step 904 makes a connection to a temporary channel to respond to the request for a session. The choice of accepting or refusing the session is made at step 906, followed by an appropriate message to the sender at step 908 or step 910, depending on the situation.

As used herein, the term file is not intended to be limited to documents but is intended to encompass other types of electronic information. Similarly, the stations 12 are illustrated as personal computers in the drawings but can be other types of computing devices, such as personal digital assistants and other handheld devices.

The foregoing discussion reveals the system and method of the present invention so that others can adapt it for various applications without omitting features that, from the standpoint of prior art, constitute essential characteristics of the generic or specific aspects of the invention. Alternative embodiments of the present invention will become apparent to those skilled in the art to which it pertains upon review of the specification, including the drawing figures. The various systems and methods showing in FIGS. 1-4 and described in the specification are merely exemplary of those suitable for use in connection with the present invention. Accordingly, the scope of the present invention is defined by the appended claims rather than the foregoing description.

We claim:

1. system for use in a computing environment for transmitting data to a plurality of receiving devices comprising:
a sending device connected to said receiving devices on a network;
means for providing a first notification;
means for providing a second notification;
means for transmitting data; and
means for recording said first and second notifications.

2. A system as recited in claim 1, wherein said means for providing a first notification is said sending device and said means for providing a second notification is said receiving device.

3. A system as recited in claim 2, wherein said means for transmitting data utilizes a single multi-cast transmission.

4. A system as recited in claim 3, wherein said single multi-cast transmission occurs after said second notification.

5. A system as recited in claim 3, wherein said single multi-cast transmission occurs after said means for providing a first notification has acted but before or without any action by said means for providing a second notification.

6. A system as recited in claim 1 further comprising means for recording information and the presence of devices that join a community.

7. A method for use in a computing environment for transmitting data to a plurality of receiving devices comprising:
requesting a time for when a data transmission can occur from a device;
providing a notification of said time at which said request can be fulfilled;
requesting said data at said time;
transmitting said data; and
making a recording of said time requesting, said data requesting, and said notification.

8. A system for use in a computing environment to manage and allocate resources in the transmitting of data from a sending device to one or more receiving devices comprising:
a data storage of network resources;
a channel manager component;
a timer;
a data storage of network characteristic; and
means for recording network notifications.

9. A system as recited in claim 8, further comprising one or more boxes, wherein each box acts as a master device for a community, and has some components in common with a station device.

10. A system as recited in claim 9, wherein said box accesses said data storage of network resources, notifies all network devices of the available resources and makes a record of the notification and the available resources.

11. A system as recited in claim 8, wherein said data storage of network resources is accessed by said sending device to request a network resource and said receiving devices record information related to said network resource for use at later point in time.

12. A system as recited in claim 9, wherein said data storage of network resources is accessed by said sending device to request a network resource and said box records information related to said network resource for use at later point in time.

13. A method for use in a computing environment to manage and allocate resources in the transmitting of data from a first device to one or more second devices comprising:
requesting a network resource;
reserving a multi-cast channel via a channel manager component;
determining an optimal time to transmit;
ensuring the availability of sufficient free bandwidth;
setting a timer;
transmitting data at the expiration of said time from said first device to said one or more second devices; and
recording activities related to network activities.

14. A system for reliably delivering digital information with or without a central server to one or more devices, without an intermediate storage, utilizing multi-cast transmission for simultaneous delivery through the allocation of network resources, and recording network communications comprising:
a data transfer medium;
a channel management component;
a storage for network resources and communications records.
a timer component; and
a bandwidth database.

15. A system for the delivery of data files and documents in a portable format to recipients in a quick and reliable manner, through allocating resources over a communications link, wherein information is sent to a plurality of other users once regardless of the number of intended recipients, wherein the number of users is not limited, the amount of data is not limited, there is no buffering between the sender and recipient is required, the speed of data transfer is guaranteed, security is preserved, and a sender receives tracking information from a receiver regarding the precise status of the electronic message.

16. A method for the delivery of data files and documents wherein the system respects the quality of service of the network in terms of use of bandwidth and latency independent of the number of users present in a multicast environment.

17. A method for use in a computing environment to manage and allocate resources in the transmitting of data from a first device to one or more second devices, wherein the control of communications bandwidth prevents the overuse of resources and flooding of a network.

18. A computer-readable medium having computer-executable components comprising:
a network resource requesting component;
a multi-cast channel reservation component;
an optimal transmission time computation component;
a component for ensuring the availability of sufficient free bandwidth;
a timer setting component;
a component for transmitting data at the expiration of said time from said first device to said one or more second devices; and
a component for recording activities related to network activities.

19. A computer readable medium having computer executable instructions for performing the method recited in claim 7.

20. A computer system having a processor, a memory and an operating environment, the computer system operable to execute the method recited in claim 7.
